(19) United States
(12) Patent Application Publication
(10) Pub. No.: US 2002/0079024 A1
(43) Pub. Date: Jun. 27, 2002

(54) Thin film magnet and production process thereof

(75) Inventors: Takeshi Araki, Tokyo (JP); Teruo Nakanishi, Tokyo (JP); Toshio Umemura, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/006,679

(22) Filed: Dec. 10, 2001

Related U.S. Application Data
(63) Continuation-in-part of application No. 09/392,787, filed on Sep. 9, 1999, now abandoned.

(30) Foreign Application Priority Data
Sep. 9, 1998 (JP) 10-254912
Aug. 9, 1999 (JP) 11-232485

(51) Int. Cl. H01F 1/057

(52) U.S. Cl. 148/302; 148/101

(57) ABSTRACT

In a thin film magnet and a production process thereof, the thin film magnet has a microstructure composed of crystalline phases of a Nd₂Fe₁₄B structure type, whose c-axis is oriented in the film-thickness direction, and amorphous phases, and each of the Nd₂Fe₁₄B type crystalline phase is isolated from the others by the interposition of the amorphous phase. This thin film magnet exhibits uniform distribution of magnetic flux and less variation in characteristics, and hence is of superior quality.

This application is a continuation-in-part application based on U.S. Ser. No. 09/392,787 filed on Sep. 9, 1999, the contents of which are hereby incorporated by reference.

### BACKGROUND OF THE INVENTION

1. Field of the Invention

This invention relates to a thin film magnet and to a production process thereof. In particular, the invention relates to a thin film magnet used in small-sized devices such as micromotors, microwave oscillators, micromachines, or used for magnetic recording media. The invention also relates to a process of producing the thin film magnet.

2. Description of the Related Art

In recent years, demand for micromagnets has increased in order to reduce the size of devices. Anisotropic Nd—Fe—B magnets which exhibit strong magnetic force are required to raise the power of the devices. Such Nd—Fe—B micromagnets are predominantly manufactured by machining Nd—Fe—B sintered magnets into desired shapes. The machining techniques for magnets are, however, approaching their limits with progressing miniaturization of the target magnets. Recently, techniques for forming an anisotropic Nd—Fe—B thin film magnet directly by sputtering or other film-formation methods have been studied as new techniques for manufacturing micromagnets.

The orientation of the crystals of conventional thin film magnets are, however, low. FIG. 1 is a cross sectional view of a conventional thin film magnet. In this thin film magnet, individual crystalline phases of the Nd₂Fe₁₄B structure type 2 are adjacent to each other, and they stress each other. Consequently, crystal growth in one direction is disturbed, and a crystallographic axis (c-axis) is irregularly oriented. The irregular orientation of c-axis creates a variation in magnetization of individual Nd₂Fe₁₄B type phases 2. The variation in the magnetization disrupts the distribution of magnetic flux and increases fluctuations in torque when such a film magnet is used in motors.

### SUMMARY OF THE INVENTION

Accordingly, objects of the present invention are to provide a high-quality thin film magnet having uniform distribution of magnetic flux and less variation in characteristics, and to provide a process of producing the thin film magnet.

The present invention provides a thin film magnet having a microstructure composed of crystalline phases of the Nd₂Fe₁₄B structure type, whose c-axis is oriented in a film-thickness direction, and amorphous phases, wherein each said Nd₂Fe₁₄B type crystalline phase is isolated from the others by the amorphous phase, and said film is formed by forming a RₓM_{1-x-y}B_{y} thin film (in the formula, R is one (1) or more elements selected from the group consisting of Nd, Pr, Tb, Ho and Dy, M is one (1) or more elements selected from the group consisting of Fe, Co and Ni and 0.11≦x≦0.15, 0.12≦y≦0.20) on a substrate by a physical deposition method while controlling a temperature of the front side of said substrate within a range of ±2° C.

Further, the present invention provides the thin film magnet, wherein said amorphous phases are ferromagnetic.

Still further, the prensent invention provides a process of producing a thin film magnet having a microstructure composed of crystalline phases of the Nd₂Fe₁₄B structure type, whose c-axis is oriented in a film-thickness direction, and amorphous phases, wherein each said Nd₂Fe₁₄B type crystalline phase is isolated from the others by the amorphous phase, comprising the step of forming a RₓM_{1-x-y}B_{y} thin film (in the formula, R is one (1) or more elements selected from the group consisting of Nd, Pr, Tb, Ho and Dy, M is one (1) or more elements selected from the group consisting of Fe, Co and Ni and 0.11≦x≦0.15, 0.12≦y≦0.20) on a substrate by a physical deposition method while controlling a temperature of the front side of said substrate within a range of ±2° C.

### BRIEF DESCRIPTION OF THE DRAWINGS

These and other features, objects, and advantages of the present invention will be apparent upon consideration of the following description of the invention in conjunction with the drawings.

FIG. 1 is a cross sectional view of a conventional thin film magnet;

FIG. 2 is a cross sectional view of a thin film magnet according to the present invention;

FIG. 3 is a cross sectional view of a thin film magnet with aggregations of crystalline phases;

FIG. 4 is a cross sectional view of a thin film magnet according to an embodiment (First Embodiment) of the invention;

FIG. 5 is a cross sectional view of a thin film magnet according to another embodiment (Second Embodiment) of the invention;

FIG. 6 show the relationship between torque and rotation angle of a motor using thin film magnets according to the Second Embodiment of the invention and one using conventional thin film magnets;

FIG. 7 is a cross sectional view of a thin film magnet according to another embodiment (Third Embodiment) of the invention;

FIG. 8 is a cross sectional view of a thin film magnet according to another embodiment (Fourth Embodiment) of the invention;

FIG. 9 shows a diagram of the relationship between torque and rotation angle of a motor using thin film magnets according to the Fourth Embodiment of the invention and one using comparative thin film magnets;

FIG. 10 is a diagram illustrating the state where overall magnetization decreases owing to inversion of magnetic spins in amorphous phases;

FIG. 11 is a illustrative diagram showing an apparatus for formation of a thin film magnet (Fifth Embodiment) of the invention;

FIG. 12 is a cross-sectional view of a thin film magnet according to the Fifth Embodiment of the invention;

FIG. 13 is a high-resolution transmission electron microscope photograph of a cross section of a thin film magnet according to the Fifth Embodiment;

FIG. 14 is a schematic vertical cross sectional view of a microstructure of a thin film magnet obtained in the course of a production process according to the First Embodiment of the invention;

FIG. 15 shows the relationship between torque and rotation angle of a motor using thin film magnets according to the Fifth Embodiment of the invention;

FIG. 16 is a diagram illustrating a microstructure of a thin film magnet according to another embodiment (Sixth Embodiment) of the invention; and

FIG. 17 shows relationship between torque and rotation angle of a motor using thin film magnets according to the Sixth Embodiment.

FIG. 18 is a graph showing temperature of the front side of the substrate during formation of the thin film magnet according to Embodiment 7.

FIG. 19 is a transmission electron microscope photograph of a cross section of a conventional thin film magnet.

FIG. 20 is a transmission electron microscope photograph of a cross section of the thin film magnet of Embodiment 7.

FIG. 21 is a drawing explaining the composition dependence of the interior structure of the thin film magnet of Embodiment 8.

### DETAILED DESCRIPTION OF THE INVENTION

FIG. 2 is a cross sectional view of a thin film magnet according to the invention, showing that the microstructure of the thin film magnet is composed of crystalline phases of the Nd₂Fe₁₄B structure type 2, whose c-axis is oriented in the film-thickness direction, and of amorphous phases 3. The Nd₂Fe₁₄B type crystalline phases 2 and the amorphous phases 3 are alternately developed. In other words, each of the Nd₂Fe₁₄B type crystalline phases is isolated from the others by the interposition of the amorphous phase.

The thin film magnet of the present invention, where individual Nd₂Fe₁₄B type crystalline phases are isolated by the interposition of the amorphous phase, can prevent mutual interference of the individual Nd₂Fe₁₄B type crystalline phases and enables crystal grains to grow in one direction. Therefore, this film magnet can provide less irregular variation in orientation of c-axis.

Such thin film magnet can be produced by a process comprising the step of forming an RₓM_{1-x-y}B_{Y} thin film (in the formula, R is one (1) or more elements selected from the group consisting of Nd, Pr, Tb, Ho and Dy, M is one (1) or more elements selected from the group consisting of Fe, Co and Ni and 0.11≦x≦0.15, 0.12 5≦y≦0.20) on a substrate by a physical deposition method while controlling a temperature of the front side of said substrate within a range of ±2° C.

Furthermore, when the amorphous phases are ferromagnetic, the (residual) magnetization of the thin film magnet, and hence its magnetic force, can be further enhanced. By forming a microstructure composed of Nd₂Fe₁₄B type crystalline phases and amorphous phases in the film deposition process, where the two types of phases are adjacent alternately, a more uniform microstructure of the thin film magnet can be obtained. As shown in FIG. 3, a microstructure composed of aggregations of plural Nd₂Fe₁₄B type crystalline phases and amorphous phases is different from that of the present invention. This microstructure is undesirable because each of the Nd₂Fe₁₄B type crystalline phases in an aggregation is not isolated from the others, and mutual interference of the Nd₂Fe₁₄B type crystalline phases occurs. This mutual interference creates irregular variations in c-axis orientation.

### EXAMPLES

The present invention is further explained by the following Examples.

First Embodiment

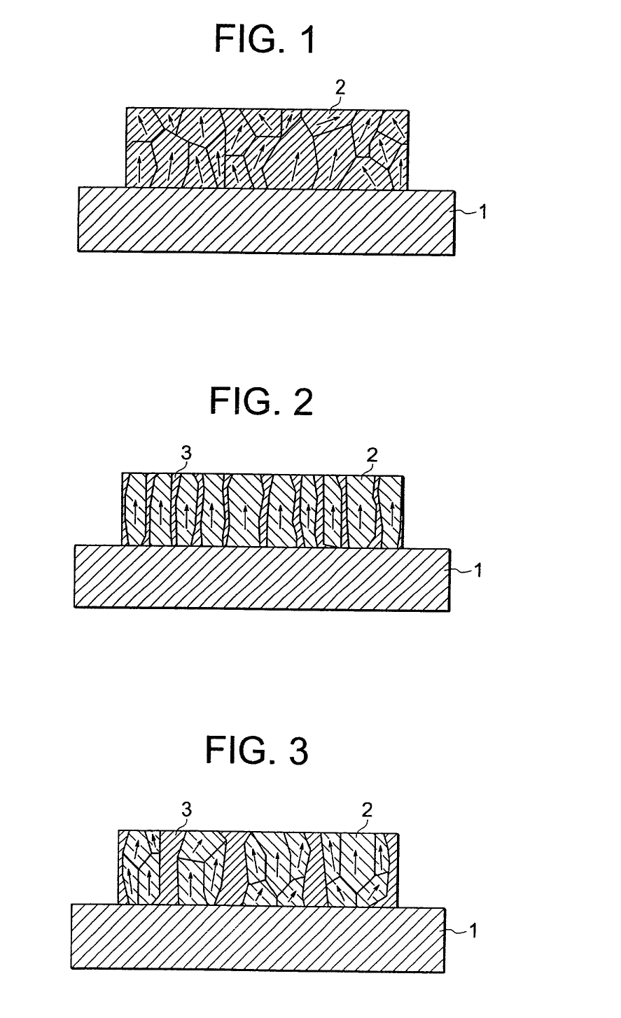

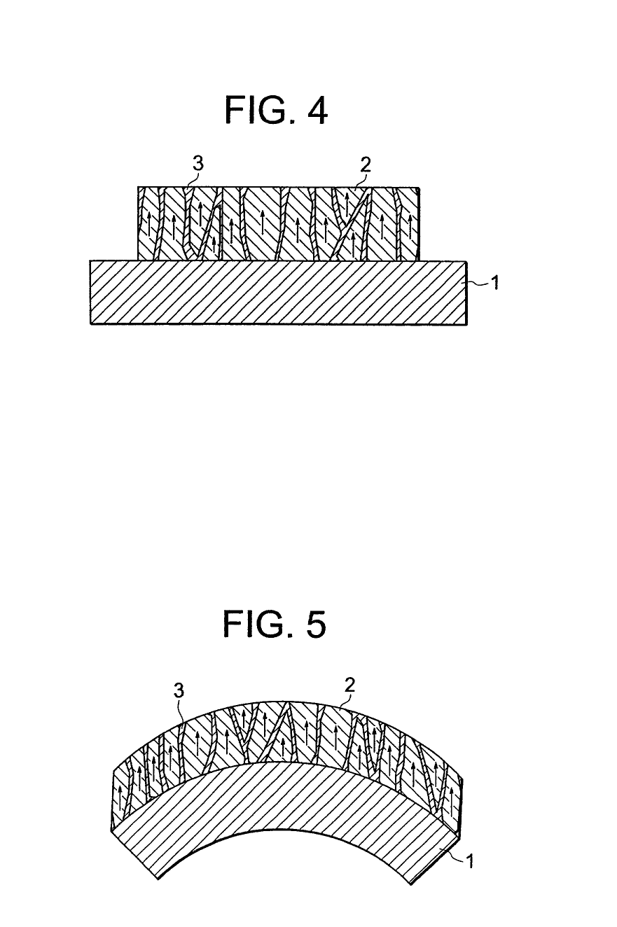

FIG. 4 is a cross sectional view of the thin film magnet according to an embodiment of the invention. The thin film magnet on a substrate 1 has a microstructure composed of Nd₂Fe₁₄B type crystalline phases 2 and amorphous phases 3. Each of the Nd₂Fe₁₄B type crystalline phases 2 is isolated from the others by the interposition of the amorphous phase 3. The thin film magnet of the invention exhibits less variation in orientation of c-axis. When this film is applied to linear motors or rotary motors, fluctuations in torque become low compared with that of a conventional equivalent (FIG. 1).

Second Embodiment

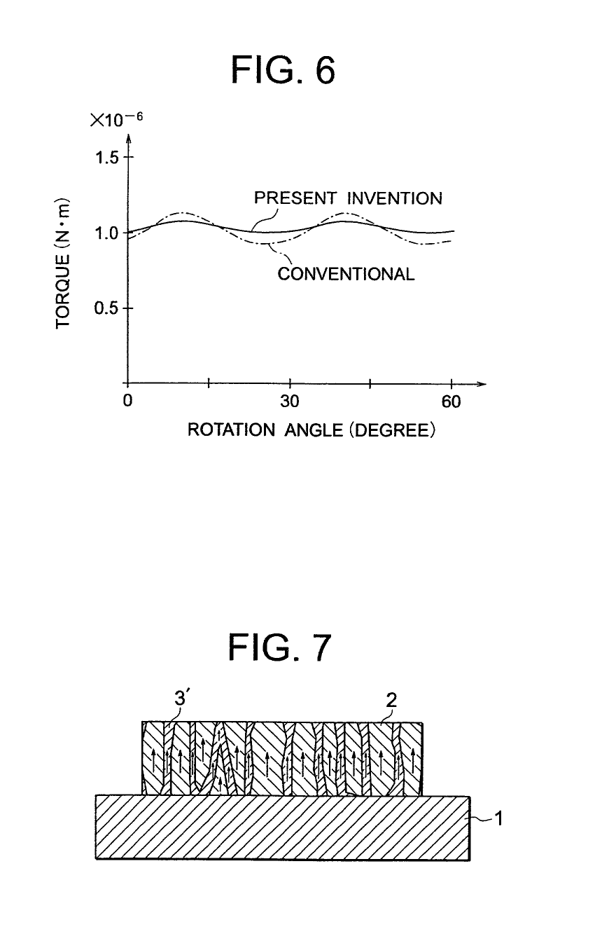

FIG. 5 is a cross sectional view of the thin film magnet according to another embodiment of the invention. The thin film magnet having a curved iron plate as the substrate 1 comprises Nd₂Fe₁₄B phases as the Nd₂Fe₁₄B type crystalline phases 2 and amorphous phases of nonmagnetic neodymium oxide as the amorphous phases 3. Each of the Nd₂Fe₁₄B type crystalline phases 2 is isolated from the others by the interposition of the amorphous phase 3. This thin film magnet was applied to a rotor of a three-phase four-pole motor with diameter of 1 mm. FIG. 6 shows the relationship between torque and rotation angle for the motor. The thin film magnet of the invention produces fewer fluctuations in torque than the conventional thin film magnet (FIG. 1). In the present invention, the Nd₂Fe₁₄B type crystalline phase 2 is not limited to the Nd₂Fe₁₄B phase and may contain one or more rare-earth elements in addition to Nd, or may contain one or more transition metal elements in addition to Fe. For example, a (Nd,Tb)₂(Fe,Co)₁₄B phase, (Nd,Tb)₂(Fe,Ni)₁₄B phase, (Nd,Tb)₂(Fe,Co,Ni)₁₄B phase, (Nd,Tb,Ho)₂ (Fe,Co,Ni)₁₄B phase, or the like can be adopted as the Nd₂Fe₁₄B type crystalline phase 2. A neodymium oxide phase, an iron oxide phase, a neodymium-boron phase, or the like can be used as the amorphous phase 3. The substrate can be fabricated from various materials, for example, iron, cobalt, nickel, titanium, or other pure metals, iron-cobalt, iron-nickel or other alloys, quartz glass, alumina or other oxides, titanium nitride or other nitrides.

Third Embodiment

FIG. 7 is a cross sectional view of the thin film magnet according to a further embodiment of the invention. The thin film magnet on a substrate 1 comprises the Nd₂Fe₁₄B type crystalline phases 2 and the ferromagnetic amorphous phases 3′. Each of the Nd₂Fe₁₄B type crystalline phases 2 is isolated from the others by the interposition of the amorphous phase 3′. Individual phases are magnetically coupled to each other by exchange interactions and thus the overall magnetization increases as compared with that according to First Embodiment (FIG. 4). The width of each phase should preferably be equal to or less than several hundred angstroms for enhancement of magnetization by exchange coupling.

Fourth Embodiment

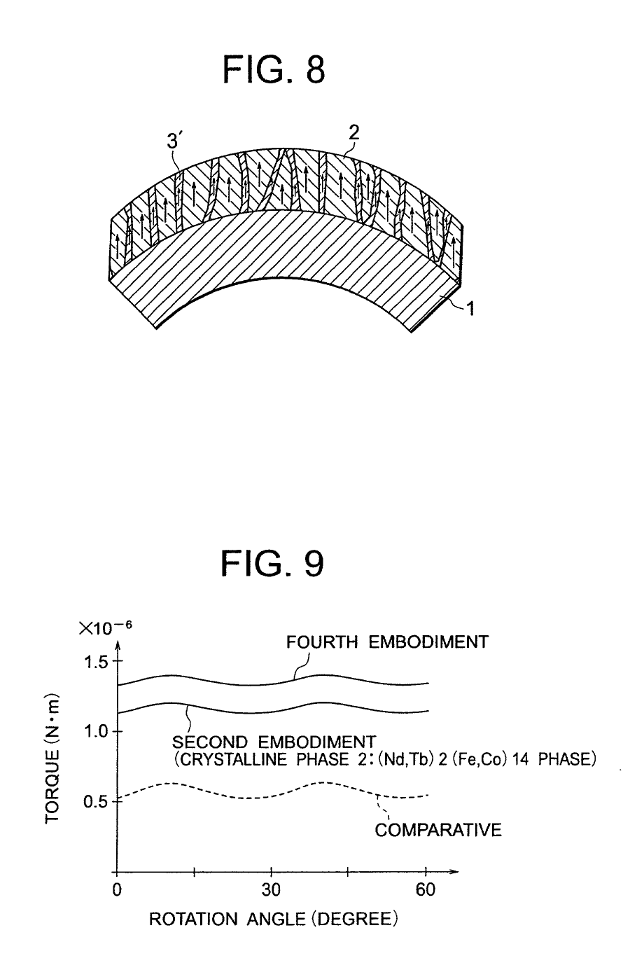

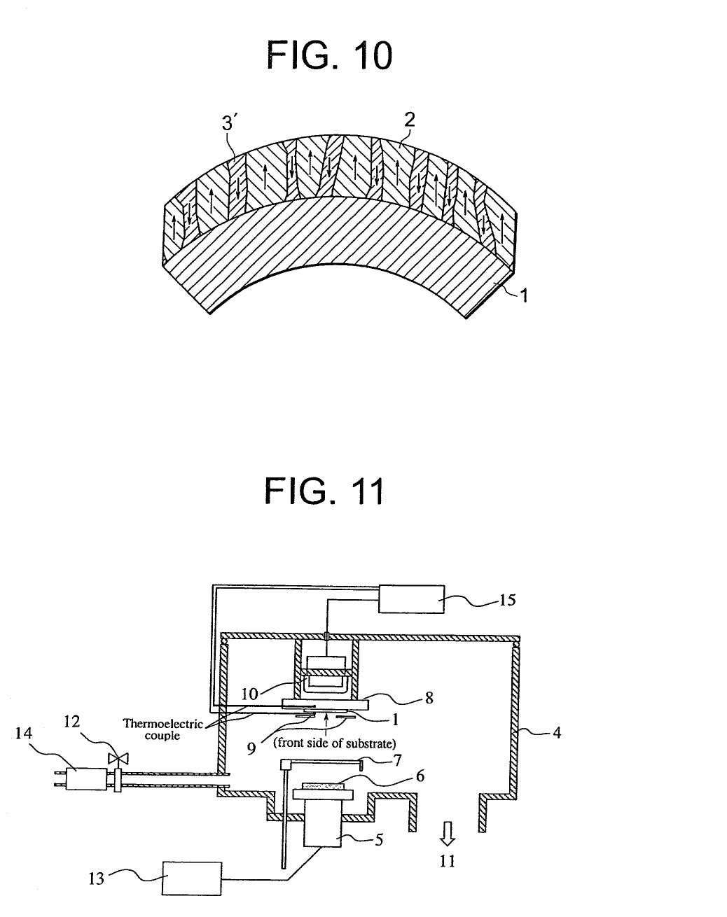

FIG. 8 is a cross sectional view of the thin film magnet according to another embodiment of the invention. The thin film magnet having a curved iron plate as the substrate 1 comprises (Nd,Tb)₂(Fe,Co)₁₄B phases as the Nd2Fe₁₄B type crystalline phases 2 and soft magnetic amorphous phases of ferromagnetic neodymium-iron-boron as the amorphous phase 3′. Each of the Nd₂Fe₁₄B type crystalline phases 2 is isolated from the others by the interposition of the amorphous phase 3′. This thin film magnet was applied to a rotor of a three-phase four-pole motor with diameter of 1 mm. FIG. 9 shows the relationship between torque and rotation angle for the motor. FIG. 9 also shows the torque curve of the motor using the thin film magnet of Second Embodiment, as illustrated in FIG. 5. Note that Second thin film magnet uses (Nd,Tb)₂(Fe,CO)₁₄B phases as the Nd₂Fe₁₄B type crystalline phase 2. As seen from FIG. 9, Fourth Embodiment of the invention provides a greater torque than Second Embodiment. The ferromagnetic amorphous phases 3′ may include, for example, an iron-boron phase, neodymium-iron phase or the like, as well as a neodymium-iron-boron phase. Furthermore, if the amorphous phases 3′ of the thin film magnet has a width of the order of micrometers, satisfactory exchange coupling effect cannot be obtained. Therefore, inversion of spins in the amorphous phases occurs, as illustrated in FIG. 10, resulting in deteriorating the overall magnetization. This leads to decrease of the motor torque as shown in the comparative example of FIG. 9. Consequently, the width of the amorphous phases should preferably be at most on the order of submicrons.

Fifth Embodiment

FIG. 11 is an illustrative diagram of an apparatus for the formation of a thin film magnet according to the invention. A vacuum chamber 4 is equipped with, as a mechanism for sputtering, a cathode electrode 5, a target 6 (a raw material of the thin film magnet) and a shutter plate 7. A substrate holder 8 opposite to the target 6 is provided with a substrate 1 and a mask 9. The mask 9 serves to form a thin film magnet at a desired location. A heater 10 serves to heat the substrate 1 during the film-formation. A thin film magnet is formed in the following manner. Initially, the air inside the vacuum chamber 4 is removed by an exhaust system 11. A gas (Ar) is then introduced via a valve 12 into the vacuum chamber 4, and voltage is applied to the cathode electrode 5 for electrical discharge and the shutter 7 is opened. As Ar atoms ionized by discharge run against the target 6, a sputtered thin film magnet is formed on the substrate 1. The power applied to the target, the gas pressure for the film formation, and the temperature of the substrate 1 are precisely controlled by a power controller 13, a mass flow controller 14, and a temperature controller 15, respectively. Thermoelectric couple is attached in the substrate holder 8 (near the back side of the substrate 1) or to the front side of the substrate 1 to refer the temperature of the substrate 1.

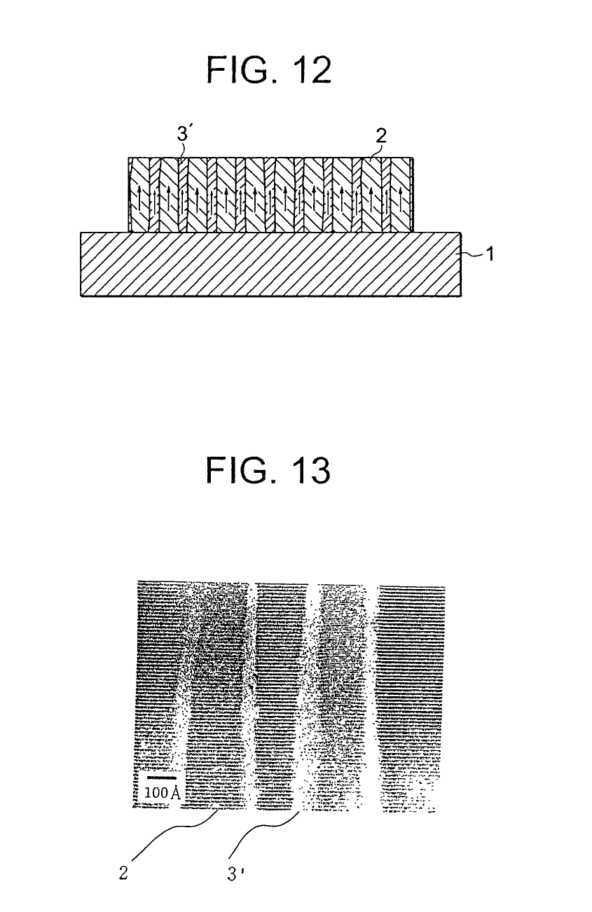

In this embodiment, a (13 at. % Nd)-(70 at. % Fe)-(17 at. % B) alloy and a titanium flat plate were respectively used as the target 6 and the substrate 1. A thin film magnet having a thickness of 1.3 μm was obtained under an Ar gas pressure of 4 Pa, at a substrate temperature of 560° C., and for the film-forming period of 60 minutes. FIG. 12 is a cross-sectional view of the thin film magnet obtained. In FIG. 12, since Nd₂Fe₁₄B type crystalline phases 2 and amorphous phases 3′ concurrently grow in the film-thickness direction, Nd₂Fe₁₄B crystal grains grow in one direction without interference with each other in the film deposition step. Therefore, a uniform microstructure can be obtained. FIG. 13 is a high-resolution transmission electron microscope photograph of a cross section of a thin film magnet according to this embodiment. As seen from FIG. 13, each of the Nd₂Fe₁₄B type crystalline phases 2 with width of several hundred angstroms is isolated from the others by the interposition of the soft magnetic neodymium-iron-boron amorphous phase 3′ with width of several tens of angstroms. Both phases are magnetically coupled to each other by exchange interactions, so that overall magnetization becomes great. This striped microstructure only grows under specific conditions which include film composition, gas pressure and temperature during the film formation, i.e., as the aforementioned conditions.

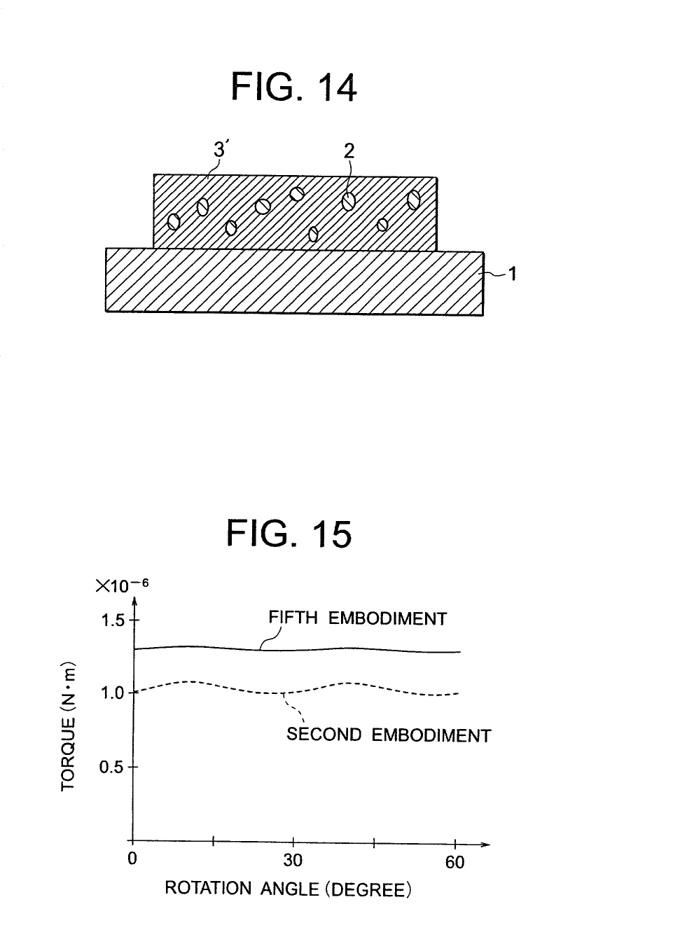

In the case of the First Embodiment (FIG. 4), the thin film magnet may be fabricated by a two-step process of, for example, initially depositing a film at a substrate temperature of 500° C. and subsequently heating the film at 580° C. for 30 minutes. As the temperature of the substrate is lower than an optimal temperature in the first step of the process, Nd₂Fe₁₄B type crystalline phases 2 are small and dispersed in a matrix of a soft magnetic amorphous phase 31, as is illustrated in FIG. 14. Therefore, by heating the film at 580° C. for 30 minutes in the second step of the process, Nd₂Fe₁₄B crystal grains grow and the microstructure shown in FIG. 4 is formed ultimately. Comparing FIG. 12 with FIG. 4, the uniformity of the former microstructure formed by the concurrent growth of oriented Nd₂Fe₁₄B type crystalline phases 2 and amorphous phases 3′ in the film deposition step is superior to that of the latter microstructure formed by two-step process mentioned above. Linear motors or rotary motors using the former thin film magnet have less fluctuation in torque than that using the latter thin film magnet. By way of illustration, a thin film magnet having curved iron plate as the substrate 1 according to Fifth embodiment was applied to a rotor of a three-phase four-pole motor rotor with diameter of 1 mm. FIG. 15 illustrates the relationship between torque and rotation angle for this motor. The torque curve of the motor according to the Second Embodiment (FIG. 5) is also illustrated in FIG. 15. FIG. 15 shows that the thin film magnet according to the Fifth Embodiment produces less fluctuation in torque than the thin film magnet according to the Second Embodiment. The former thin film magnet can yield greater torque than the latter thin film magnet since the amorphous phases in the former are ferromagnetic; whereas the amorphous phases in the latter are nonmagnetic.

Sixth Embodiment

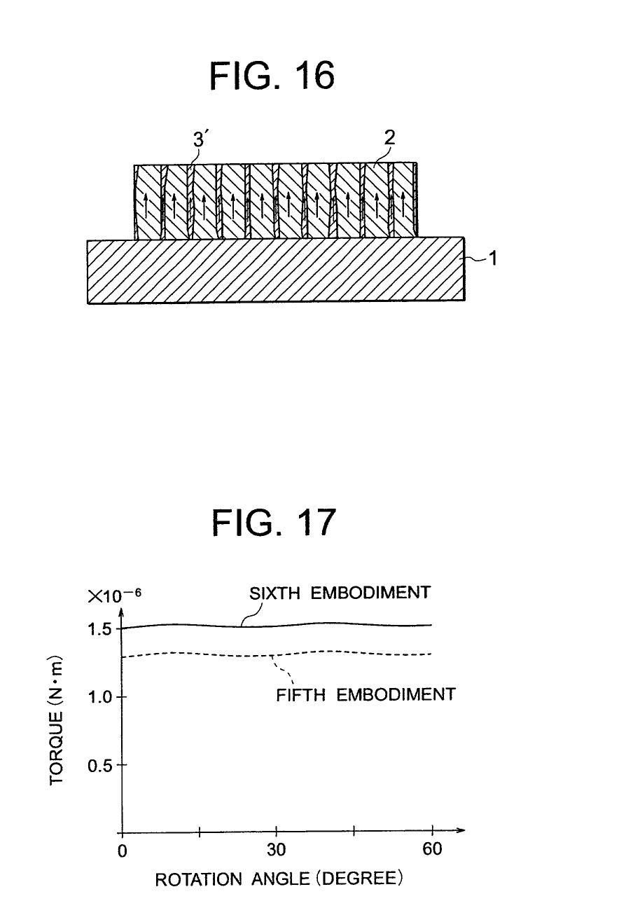

In this embodiment, a (13 at. % Nd)-(74 at. % Fe)-(13 at. % B) alloy and a flat titanium plate were respectively used as the target 6 and the substrate 1. A thin film magnet having a thickness of 1.3 μm was obtained under an Ar gas pressure of 4 Pa, at a substrate temperature of 560° C., and for the film forming period of 60 minutes. FIG. 16 shows the microstructure of the thin film magnet obtained. In FIG. 16, since Nd₂Fe₁₄B type crystalline phases 2 and amorphous phases 3′ grow concurrently in the film-thickness direction, Nd₂Fe₁₄B crystal grains grow in one direction without interfering with each other in the film deposition step. Therefore, a uniform microstructure can be obtained. In addition, this microstructure has a greater volume fraction of Nd₂Fe₁₄B type crystalline phases and can therefore yield greater magnetic force than that of the thin film magnet according to Fifth Embodiment. Table 1 shows film compositions of these thin film magnets. The thin film magnet according to Sixth Embodiment has a film composition nearer to a stoichiometric composition of Nd₂Fe₁₄B than that according to the Fifth Embodiment, so that the former volume fraction of Nd₂Fe₁₄B type crystalline phases is greater than the latter.

Linear motors or rotary motors using the thin film magnet according to this embodiment can yield greater torque than that using the thin film magnet according to Fifth Embodiment. By way of example, a thin film magnet having a curved iron plate as the substrate 1 was applied to a rotor of a three-phase four-pole motor with diameter of 1 mm. FIG. 17 illustrates the relationship between torque and rotation angle for the motor. The torque curve of the motor according to Fifth Embodiment is also shown in FIG. 17. This result shows that the thin film magnet according to the Sixth Embodiment provides greater torque than that according to Fifth Embodiment.

TABLE 1

| | Nd (at. %) | Fe (at. %) | B (at. %) |
|---|---|---|---|
| Sixth Embodiment | 12 | 75 | 13 |
| Fifth Embodiment | 12 | 71 | 17 |

Seventh Embodiment

In this embodiment, a 13 at. % Nd-72 at. % Fe-15 at. % B alloy and a flat titanium plate were used as the target 6 and the substrate 1, respectively. A thin film magnet having a thickness of 1.3 μm was obtained under an Ar gas pressure of 4 Pa, at a substrate temperature of 560° C., and for a film forming period of 60 minutes.

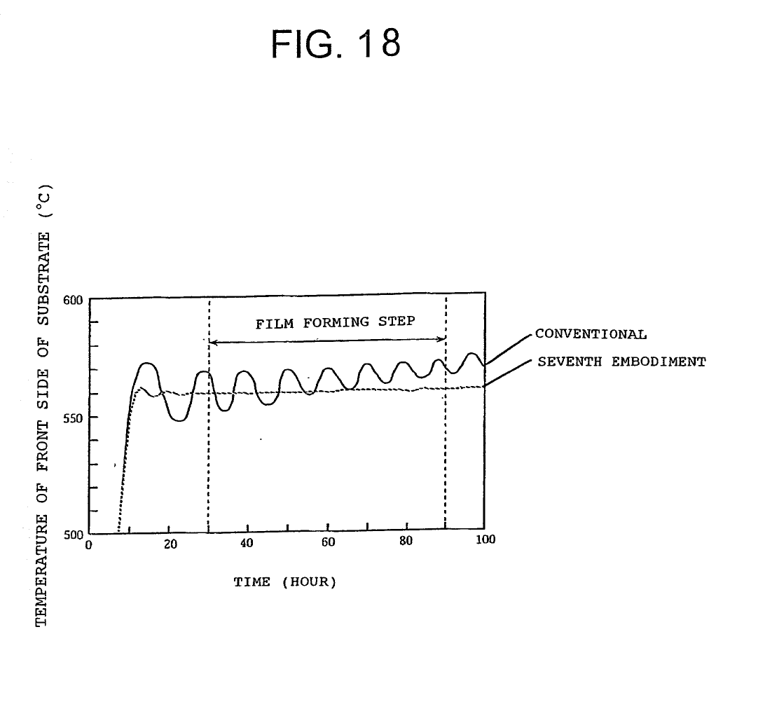

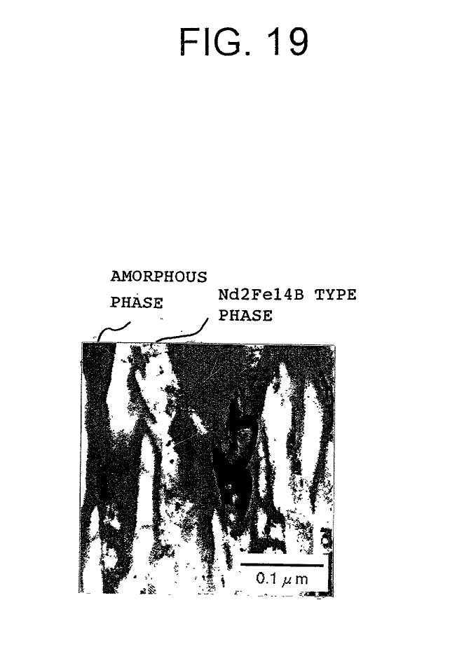

FIG. 18 is a drawing showing temperatures of the substrate while forming the film. For the conventional film magnet, temperature of the substrate holder 8, which is corresponded to that of the back side of the substrate 1, has been maintained with 560° C. However, a temperature of the front side of the substrate actually fluctuated greatly as shown by conventional example in FIG. 18 because the front side temperature is affected by plasma temperature. Consequently, an obtained interior structure of the conventional film magnet was not uniform, as shown in FIG. 19, and this structure corresponded to that shown in FIG. 3 and thus differed from the structure of the present invention as described above.

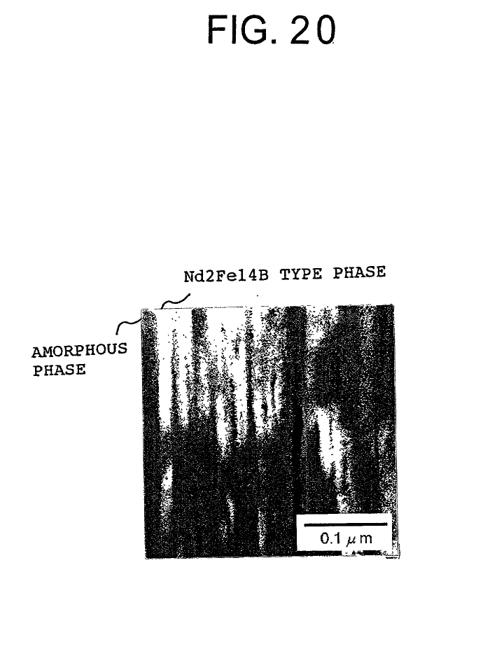

On the other hand, in the present embodiment 7 temperature of the front side of the substrate is maintained with 560° C.±2° C. under feedback-control, as shown by the broken line in FIG. 18. Accordingly, as shown in FIG. 20, it is possible to obtain a uniform interior structure comprising crystalline phases of the Nd₂Fe₁₄B structure type, a c-axis thereof being oriented in a film-thickness direction, and amorphous phases, each Nd₂Fe₁₄B type crystalline phase being isolated from the others by the amorphous phase.

Eighth Embodiment

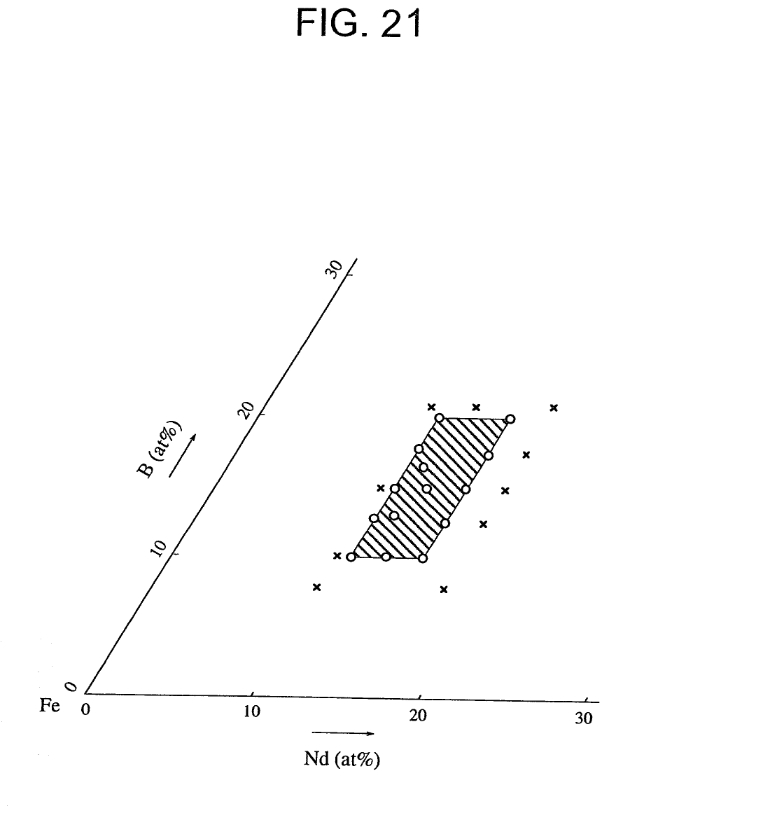

In the present embodiment, Nd—Fe—B thin film magnets of various compositions were made and the composition dependence of the interior structure was examined. Each Nd—Fe—B alloy target 6 was prepared corresponding to the composition of each thin film magnet and films were formed while maintaining a temperature of the front side of the substrate with 550° C.±2° C. under feedback-control and thin film magnets of various compositions were thus made. All of the films were 1.0 μm in thickness, the substrate 1 was a flat titanium plate, an Ar gas pressure was 4 Pa and the film forming period was 60 minutes. The results are shown in FIG. 21. It was found that a uniform interior structure comprising crystalline phases of an Nd₂Fe₁₄B structure type, a c-axis thereof being oriented in a film-thickness direction, and amorphous phases, each Nd₂Fe₁₄B type crystalline phase being isolated from the others by the amorphous phase, was obtained at the oblique line portion (Nd: 11 to 15 at %, B: 10 to 20 at %).

Ninth Embodiment

In the present embodiment, a target 6 of 13 at %R-71at %M-16at %B alloy and (R is a rare earth element and M is a transition metal) a substrate 1 of a flat titanium plate were used. A film was formed while controlling a temperature of the front side of the substrate with Tx±2° C. and a thin film magnet of 1.3 μm in thickness was obtained. An Ar gas pressure was 4 Pa and the film forming period was 60 minutes. Table 2 shows the relationship between Tx and the interior structure. It was understood that the interior structure of the present invention may be achieved for the various thin films by selecting an appropriate Tx.

TABLE 2

| | | Interior |
|---|---|---|
| | | Structure of the |
| | | Present Invention |
| | | ◯ obtained |
| R-M-B | Tx (° C.) | X not obtained |
| Nd—Fe—B | 600 | X |
| Nd—Fe—B | 550 | ◯ |
| Nd—Fe—B | 500 | X |
| Nd—Co—B | 560 | ◯ |
| Nd—Co—B | 540 | ◯ |
| Pr—Fe—B | 600 | X |
| Pr—Fe—B | 530 | ◯ |
| Dy—Fe—B | 600 | X |
| Dy—Fe—B | 530 | ◯ |
| Tb—Fe—B | 530 | ◯ |
| Ho—Fe—B | 520 | ◯ |

As described above, in the invention of the thin film magnet, individual Nd₂Fe₁₄B type crystalline phases are isolated from each other by the interposition of an amorphous phase, and therefore mutual interference of Nd₂Fe₁₄B crystal grains can be prevented and crystal grains can grow in one direction. Thus, this thin film magnet has less irregular variation in orientation of crystalline axes and uniform distribution of magnetic flux. Consequently, when this thin film magnet is applied to a motor, fluctuations in torque can be advantageously minimized. In addition, the decrease of irregular variation in orientation of c-axis means less variation in characteristics of and higher quality of the thin film magnet. Therefore, the thin film magnet improves the quality and reliability of the devices such as microwave oscillators, polarization devices by Faraday rotation. As the thin film magnet of the invention is a vertically magnetized film, the use of the thin film magnet as a magnetic recording medium can achieve high density recording.

By rendering the amorphous phase ferromagnetic, the magnetization of, and therefore the magnetic force of, the thin film magnet can be further enhanced. Hence, torque of motors and other devices becomes greater by using this thin film magnet.

Where the film formation on a substrate is conducted such that each of the Nd₂Fe₁₄B type crystalline phases is isolated from the others by the interposition of the amorphous phase, preferably in a manner where both phases grow concurrently in the film-thickness direction, a more uniform microstructure can be obtained. Therefore, quality of the thin film magnet becomes higher. Furthermore, less fluctuation in torque can also be obtained when the thin film magnet is used in a motor. In addition, increase in volume fraction of the Nd₂Fe₁₄B type crystalline phase further enhances the magnetic force of the thin film magnet. Hence, torque of motors and other devices increases further by using this thin film magnet.

While the invention has been described in detail and with reference to specific embodiments thereof, it will be apparent to one of ordinary skill in the art that various changes and modifications can be made therein without departing from the spirit and scope thereof.

What is claimed is:

1. A thin film magnet having a microstructure composed of crystalline phases of the Nd₂Fe₁₄B structure type, whose c-axis is oriented in a film-thickness direction, and amorphous phases, wherein each said Nd₂Fe₁₄B type crystalline phase is isolated from the others by the amorphous phase, and said film is formed by forming a RₓM_{1-x-y}B_{y} thin film (in the formula, R is one (1) or more elements selected from the group consisting of Nd, Pr, Tb, Ho and Dy, M is one (1) or more elements selected from the group consisting of Fe, Co and Ni and 0.11≦x≦0.15, 0.12≦y≦0.20) on a substrate by a physical deposition method while controlling a temperature of the front side of said substrate within a range of ±2° C.

2. The thin film magnet according to claim 1, wherein said amorphous phases are ferromagnetic.

3. A process of producing a thin film magnet having a microstructure composed of crystalline phases of the Nd₂Fe₁₄B structure type, whose c-axis is oriented in a film-thickness direction, and amorphous phases, wherein each said Nd₂Fe₁₄B type crystalline phase is isolated from the others by the amorphous phase, comprising the step of forming a RₓM_{1-x-y}B_{y} thin film (in the formula, R is one (1) or more elements selected from the group consisting of Nd, Pr, Tb, Ho and Dy, M is one (1) or more elements selected from the group consisting of Fe, Co and Ni and 0.11≦x≦0.15, 0.12≦y≦0.20) on a substrate by a physical deposition method while controlling a temperature of the front side of said substrate within a range of ±2° C.
